(19) United States
(12) Patent Application Publication
(10) Pub. No.: US 2010/0083506 A1
(43) Pub. Date: Apr. 8, 2010

(54) HEAD SECTION FOR A ROTARY CUTTING DEVICE INCLUDING BLADES AND INDIVIDUAL CUTTING LINES

(76) Inventor: James A. Bennett, Columbia, SC (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/244,913

(22) Filed: Oct. 3, 2008

(51) Int. Cl. B25F 3/00

(52) U.S. Cl. 30/122

(57) ABSTRACT

A head section for a rotary cutting device includes a body portion, a plurality of cutting lines, and a plurality of blades, wherein the plurality of cutting lines are selectively mounted to the body portion without any disassembly of the head section, and the plurality of blades are selectively mounted to the body portion without any disassembly of the head section. Thus, the head section is selectively configurable, without any disassembly of the head section, to hold only cutting blades in a cutting blade configuration and to hold only cutting lines in a cutting line configuration.

### FIELD OF THE INVENTION

The present invention generally relates to a head section for a rotary cutting device. More particularly, it relates to a head section having both mechanisms for facilitating the installation and removal of blades therefrom and mechanisms for facilitating the installation and removal of single lengths of individual cutting lines. This invention also relates to methods for installing and removing a blade and methods for installing and removing a single length of cutting line from a head section for a rotary cutting device

### BACKGROUND OF THE INVENTION

In gardening, frequently tools are used for cutting vegetation, and in particular for cutting grass, which are based upon the use of cutting lines. The latter are made to project radially from mowing heads, which, fitted to the end of a rotating shaft, are made to rotate at a high speed. The centrifugal force radially extends the lines projecting from the mowing head, so that by rotating they cut the vegetation.

In some mowing heads of this type, the cutting line is applied in the form of single lengths, one end of which is anchored to the mowing head whilst the opposite end projects radially from the mowing head itself. The length of the individual lengths or portions of cutting line is sufficient to carry out cutting of a certain amount of vegetation. Once the lengths of cutting line are worn out, they are simply replaced with new lengths.

Some examples of mowing heads of this type are described in the U.S. Pat. Nos. 5,896,666, 5,758,424, 5,887,348. The mowing heads described in these patents have a rotating body, which can be engaged to a motor shaft. The rotating body has a peripheral edge, and anchorage members for lengths of cutting line are arranged about the peripheral edge. More particularly, each anchorage member has an eccentric oscillating element elastically loaded against a surface of contact fixed to the body of the mowing head. The length of cutting line is blocked against the mowing head as a result of the elastic loading exerted by the eccentric oscillating element against the contact surface. The centrifugal force that is generated during rotation, which is applied on the cutting line projecting from the mowing head and tends to slide the cutting line out of the seat defined between the fixed surface and the eccentric element, increases the force with which the eccentric element presses against the fixed surface, pinching the cutting line. This guarantees effective grip of the cutting line during operation.

Another example of mowing heads employing replaceable individual lengths of cutting line are shown in U.S. Pat. No. 6,401,344. The mowing heads described in this patent have anchorage members that extend across a cutting line passageway in the rotating body. The anchorage member includes apertures that can be aligned with the cutting line passageway to open the same to receipt of the individual length of cutting line. The anchorage member is biased such that these apertures are normally not aligned with the cutting line passage, but a push button accessible at the exterior of the mowing head can be manipulated to place the apertures in such alignment. When aligned with the cutting line passageway, an individual length of cutting line can be inserted into both the cutting line passageway and the aperture in the anchorage member. Upon release of the push button, the aperture moves out of alignment with the cutting line passageway and causes the cutting line to be pinched between the anchorage member aperture and the sidewall of the cutting line passageway.

Other head sections for rotary cutting devices employ blades that extend outwardly from the head section such that, when the head section is rotated, the blades are also rotated to cut vegetation or other items as necessary. The blades are typically secured to the head section by screw connections or doweling so as to fasten the blades respectively between a body portion and a cap portion, and the cap portion needs to be removed in order to change a damaged or worn-out blade. The body and cap structures thus present an inconvenience when changing the blades, and there is a possibility of incorrect assembly, which may affect operational safety. In other head sections, special tools must be used to mount and remove blades, and such is also undesirable, as a tool-less mount and removal is preferable.

Most head sections for rotary cutting tools include only one means for trimming vegetation, be it a cutting line, a cutting blade or other trimmer element. Because different trimmer elements might be particularly suited for different trimming tasks, some head sections provide means for selectively receiving a desired trimmer element. For example, with some head sections, it is possible to remove a portion of the head section to remove a trimmer line assembly, and thereafter replace the trimmer line assembly with cutting blades and cutting blade retention elements. However, this requires at least a partial removal of head section elements, demanding time and some level of competency with tools and the like to effect the exchange of trimmer elements. Thus, a need exists in the art for a head section that is adapted to selectively receive either lengths of trimmer line or blades, as desired by the end user, wherein the installation of the desired trimmer element can be effected without the use of tools and without the need to disassemble any portion of the head section.

### SUMMARY OF THE INVENTION

In general, the present invention combines into a single cutting head section both easily installed and removed blades and easily installed and removed lengths of individual cutting lines. The invention is provided to address the need for a head section for a rotary cutting device, wherein the head section can be selectively configured to employ either blades or individual lengths of cutting line, and can be so selectively configured without the use of tools and without having to disassemble any portion of the head section. The invention also addresses the need for a selectively configurable head section that can be mounted to a rotary shaft of a rotary cutting device without the use of tools and without having to disassemble any portion of the head section.

In accordance with yet another embodiment, the present invention provides a head section for a rotary cutting device. The head section includes a body portion that includes a blade passage defined between a blade entrance opening and a blade exit opening. A blade fastening mechanism is positioned in the blade passage and includes a blade engaging member. The blade engaging member is biased by a biasing mechanism to extend across the blade passage at a blade install position. The blade engaging member is movable against the bias to clear the blade passage. A blade having a mount aperture proximate an insertion end thereof is secured to the body portion when the mount aperture occupies the blade mount position and the blade engaging member extends through the mount aperture. The body portion also includes a cutting line mount assembly in said body portion, and a cutting line selectively secured to said body portion by said cutting line mount assembly.

### BRIEF DESCRIPTION OF THE DRAWINGS

FIG. 1 is a perspective view of relevant portions of a rotary cutting device, showing the head section in accordance with this invention having blades and individual lengths of cutting lines extending therefrom, with it being understood that the concurrent installation of both blades and cutting lines is not likely (though it is possible);

FIG. 2 is a perspective view of the head section of this invention, shown with the decorative cap portion removed from the body portion;

FIG. 3 is a top plan view of the body portion;

FIG. 4 is a perspective view of a blade fastening mechanism received in the head section;

FIG. 5 is a cross-sectional view of the head section, showing a blade fastened to the head section by the blade fastening mechanism;

FIG. 6 is a cross-sectional view showing the interaction of a blade and the blade fastening mechanism during the initial mounting step for mounting a blade to the head section;

FIG. 7 is a cross-sectional view showing the interaction of a blade and the blade fastening mechanism during the initial removing step for removing a blade to the head section;

FIG. 8 is a bottom plan view taken from the bottom of the head section, showing a last step in removing a blade from the head section;

FIG. 9 is a top plan view of a blade; and

FIG. 10 is an exploded perspective view of the head section, showing particularly the assembly of anchorage members for individual lengths of cutting line; and

FIG. 11 is a top plan view of the head section shown with the cap removed and with individual lengths of cutting line secured thereto by anchoring elements;

FIG. 12 is a top plan view of the head section shown with the cap removed and while the head section is rotated so as to show the effects of the rotation on the cutting lines and anchorage elements;

FIG. 13 is a perspective view of the electric oscillating element and its interaction with a torsion spring;

FIG. 14 is a top plan view of another embodiment of a head section, shown with the cap portion removed from the body portion and oriented to show their internal structures, the head section having an alternative structure for securing individual lengths of cutting line thereto; and

FIG. 15 is a top plan view of the head section embodiment of FIG. 14, shown with the cap portion and body portion joined as they would be in use.

### DETAILED DESCRIPTION OF THE ILLUSTRATIVE EMBODIMENTS

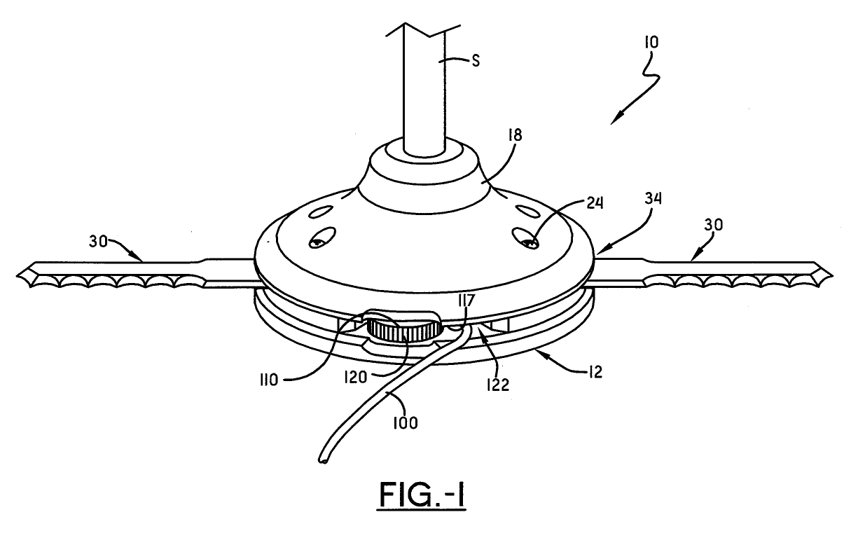

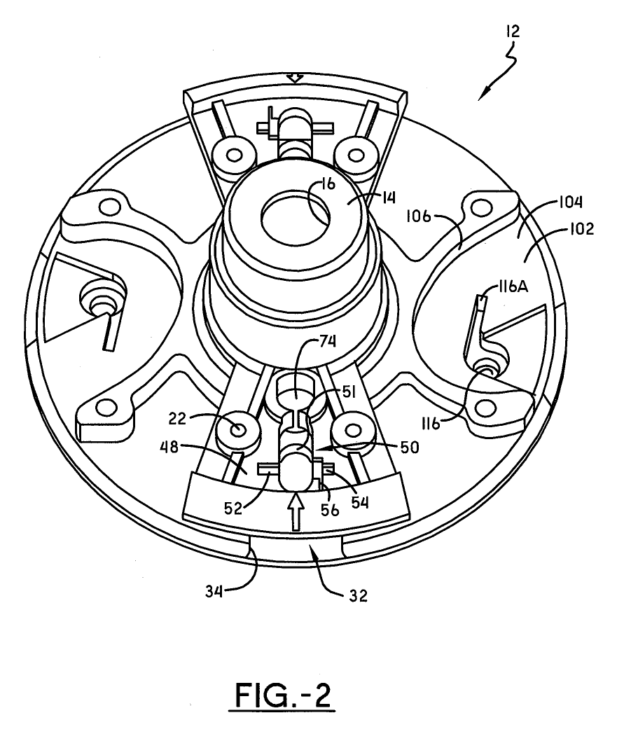

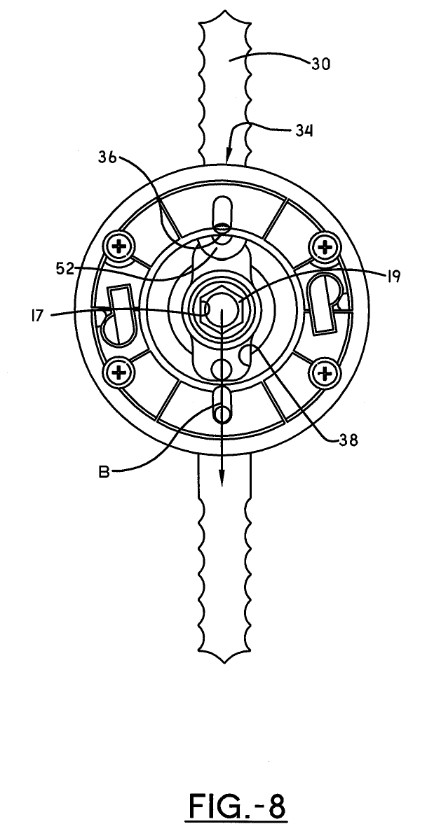

Referring now to FIGS. 1 and 2, a head section for a rotary cutting device in accordance with this invention is shown and designated by the numeral 10. Head section 10 includes body portion 12, which is preferably of one piece to simplify manufacturing and increase structural integrity. Body portion 12 includes axial member 14, which connects to the rotary shaft S of a rotary cutting device at axial bore 16. In a particular embodiment, axial bore 16 is that, as seen in FIG. 8, opens to a hexagonal bore 17 accessed at the underside of body portion 12. The transition from the axial bore 16 to the hexagonal bore 17 provides a mounting ledge 19. With such an embodiment, no tools are needed to secure the head section 10 to the rotary shaft S. Particularly, a bolt or nut having a hexagonal head (not shown) is inserted into the hexagonal bore 17 so that its hexagonal head rests on the mounting ledge 19, and the bolt or nut is then mated with a nut or bolt provided by the rotary shaft S, as known in the art. Thus, the mounting ledge 19 is sandwiched between a nut or bolt element and the corresponding mating portion of the rotary shaft S, and the head section 10 is mounted without tools. A decorative cap 18 is preferably provided to be removably secured to body portion 12, as shown by the employment of through apertures in cap 18, threaded bores 22, in body portion 12, and threaded fasteners 24. It will be readily appreciated that other means could be used for fastening the cap to the body portion.

In FIG. 1, two blades 30 and two individual lengths of cutting lines 100 are shown secured to body portion 12. Though it is possible to secure all four of these cutting elements to the body potion 12 at one time, it will be appreciated that the rotary cutting device will typically be used with either the two blades 30 or the two cutting lines 100 secured thereto for cutting vegetation during rotation of the head section 10. It should also be appreciated that the head section 10 could be shaped to accommodate more or less blades or more or less cutting lines, as desired. In this embodiment, each set of cutting elements—blades and cutting lines—are offset radially about the head section 10 by 180 degrees. The blades 30 might typically be employed for cutting thick weeds or shrubs, while the cutting lines might typically be employed for cutting or trimming grass. The securing of the blades 30 is first disclosed, with disclosure of the securing of the cutting lines 100 following.

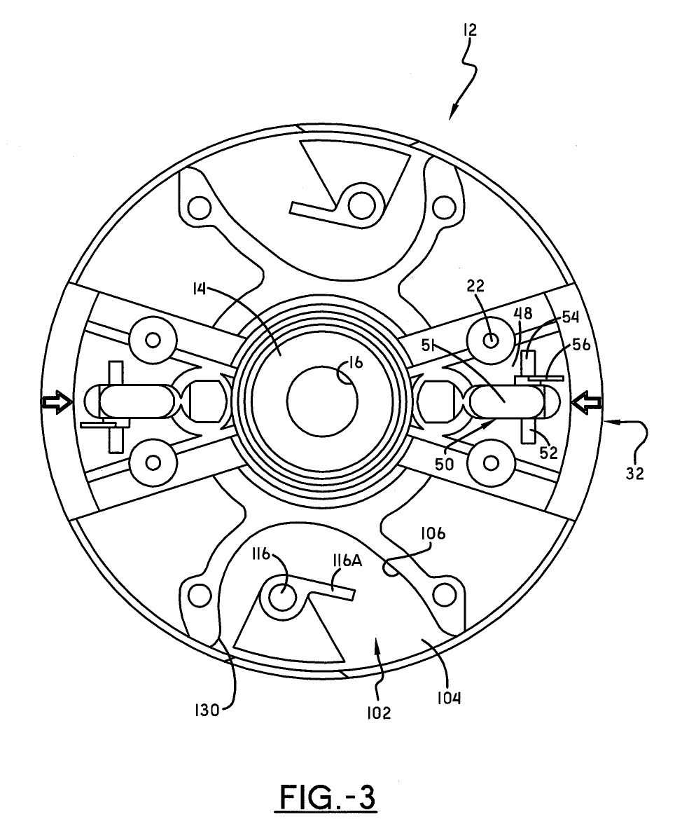

Preferably, each blade 30 is secured to body portion 12 in the same manner, and, referring now to FIGS. 3-6, the structures used to secure a blade 30 to body portion 12 are shown and described. Body portion 12 is structured to define a blade passage 32 for the receipt of blade 30. Blade passage 32 extends through body portion 12, from a blade entrance opening 34, at the periphery of body portion 12, to a blade exit opening 36, at a central cavity 38 in body portion 12. A fastening mechanism is positioned to interact with blade 30 as it is inserted into blade passage 32. The fastening mechanism is such that the operator of the rotary cutting device employing the head section 10 of this invention can quickly and easily either secure a blade 30 to head section 10 or remove blade 30 therefrom, for replacement or otherwise, without the use of any special tools.

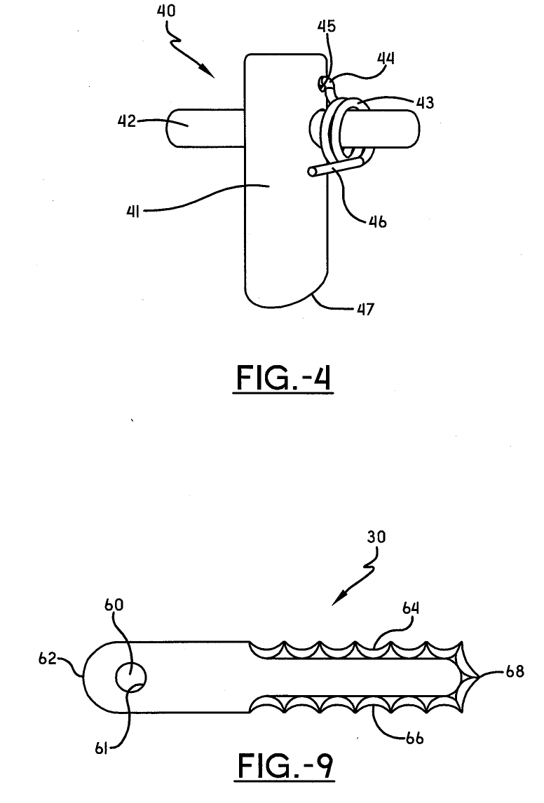

With particular reference to FIG. 4, it can be seen that a first embodiment of a fastening mechanism is shown and designated by the numeral 40. Fastening mechanism 40 includes blade engaging member 41, extending from lateral pin 42. Torsion spring 43 is mounted on lateral pin 42 to act as a biasing member. More particularly, torsion spring 43 includes an arm 44 that extends into a bore 45 in that portion of blade engaging member 41 that extends above lateral pin 42. From arm 44, torsion spring 43 coils around lateral pin 42 and provides an extension 46. The torsion spring is loaded by relative movement between the arm 44 and extension 46, and serves to bias biasing blade engaging member 41 to a blade mount position in head section 10, as will be explained more fully below.

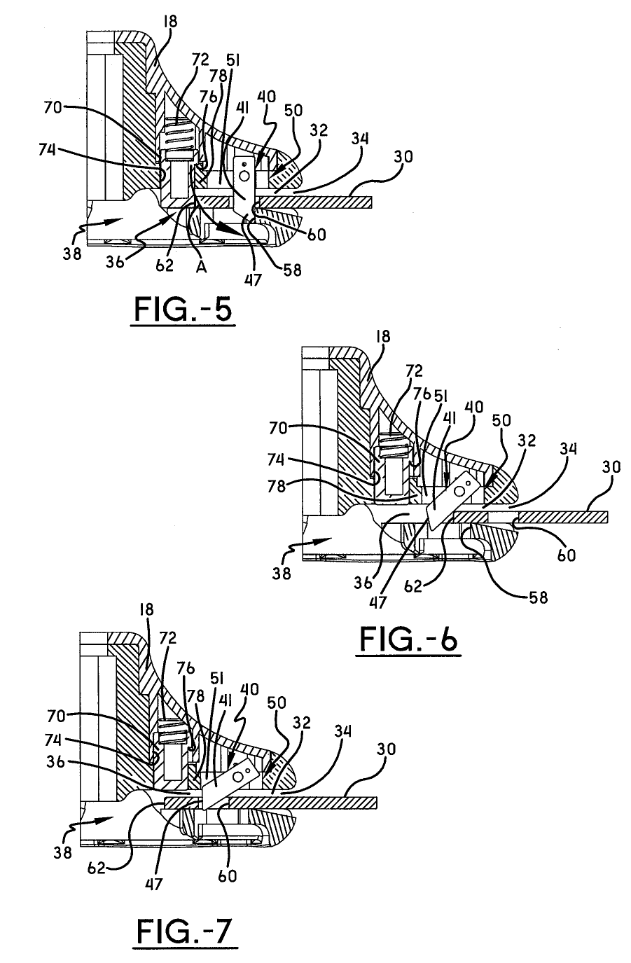

As seen in FIGS. 2 and 3, top surface 48 of body portion 12, which is accessed by the removal of cap 18, includes holding hole 50, defining a passage 51 from top surface 48 to blade passage 32. Holding hole 50 includes lateral pin receipt 52, extending into body portion 12, from top surface 48, to provide support surface 54 for lateral pin 42, and spring receipt 56, which is similarly formed to provide a support surface for an extension 46 (FIG. 4) of torsion spring 43. As appreciated from consideration of FIGS. 3, 5 and 6, fastening mechanism 40 is received in holding hole 50 with extension 46 of torsion spring 43 received in spring receipt 56, and with lateral pin 42 received in lateral pin receipt 52 such that blade engaging member 41 extends down through passage 51, across blade passage 32 and into stop channel 58 (FIGS. 5 and 6) formed in body portion 12. Torsion spring 43 urges blade engaging member 41 in the direction of arrow A so that distal end 47 of blade engaging member 41 contacts stop channel 58, positioning blade engaging member 41 transversely across blade passage 32. It should be apparent that removal of decorative cap 18 provides access to fastening mechanisms 40 and their respective holding holes 50.

In an embodiment of this invention, safety button 70 is biased by compression spring 72 to extend across blade passage 32 and block off blade exit opening 36. As seen in FIGS. 2 and 5-7, body portion 12 includes a safety button aperture 74 to receive safety button 70, and compression spring 72 is compressed between safety button 70 and the underside of cap 18 so as to constantly bias safety button 70 downwardly to the position of FIG. 5, blocking blade exit opening 36. Movement of safety button 70 is limited by contact between seat extension 76 of safety button 70 and stop surface 78 on body portion 12. Safety button 70 can be accessed at central cavity 38 to be pushed upwardly against compression spring 72 so that button 70 does not block blade passage 32. Safety button 70 helps ensure that blade 30 is not accidentally forced toward and into central cavity 38 during use, as will be better appreciated from the disclosure that follows regarding securing and removing a blade 30 from head portion 10.

To describe how a blade is secured to and removed from head portion 10, the structure of a blade 30 is shown in FIG. 9. Blade 30 is provided with mount aperture 60, defined by aperture wall 61, proximate insertion end 62. Sides 64, 66 preferably provide appropriate cutting contours, as does distal end 68. As seen in FIGS. 5 and 6, to secure blade 30 to head section 10, insertion end 62 is advanced into blade passage 32 through blade entrance opening 34, toward blade exit opening 36 (FIG. 6). As insertion end 62 advances, it contacts that portion of blade engaging member 41 that extends across its path, and forces it to pivot opposite the direction of arrow A, on the support provided by lateral pin 42, against the bias of torsion spring 43. As seen in FIGS. 6 and 7, blade engaging member 41 is moved against the bias of torsion spring 43 until mount aperture 60 aligns with distal end 47 of blade engaging member 41. At this point, distal end 47 will be forced into mount aperture 60 under the bias of torsion spring 43, and it will be appreciated that the beveled surface of distal end 47 facilitates this entry into mount aperture 60. From this position, blade 30 is pulled back in the direction of blade entrance opening 34, which motion permits blade engaging member 41 to pivot under the force of torsion spring 43 to extend through mount aperture 60 and take up the blade mount position as shown in FIG. 5. During this mounting step, safety button 70 is pushed upwardly to open blade exit opening 36 and thereby permit insertion end 62 of blade 30 to extend into central cavity 38. This is necessary so that mount aperture 60 can align with blade engaging member 41 as just described. Once blade 30 is moved to the position of FIG. 5, safety button 70 is released so that it will return to block blade exit opening 36 under the force of compression spring 72.

To remove blade 30 from head section 10, blade exit opening 36 is opened by pushing upwardly on safety button 70, and insertion end 62 of blade 30 is advanced from its position at the blade mount position of FIG. 5 toward blade exit opening 36. As insertion end 62 advances, aperture wall 61 forces blade engaging member 41 to pivot opposite the direction of arrow A, thus disengaging from mount aperture 60 and, eventually, insertion end 62 of blade 30 exits blade passage 32 at blade exit opening 36, and enters central cavity 38, as seen in FIG. 8. Once in the position shown in FIG. 8, insertion end 62 can be grasped, and the entire blade 30 can be removed from head portion 10 by pulling blade 30 in the direction of arrow B.

With the structure described herein, a blade 30 can be mounted to and removed from the head section 10 without the use of any special tools, and, indeed without tools of any kind. A blade 30 can be mounted to the head section 10 simply by using one's hands, and without disassembling the head section 10 in any way. Certain elements will pivot and reconfigure, as described, but the head section 10 is always configured to receive a blade 30 at a blade passage 32, and to permit removal of a blade 30 mounted at a blade passage 32. No cap portion, such as decorative cap 18, or other portion of the head section 10 need be removed or reconfigured to accept a blade 30.

Similarly, with reference to FIGS. 1-3, 10 and 11, individual lengths of cutting lines 100 can be selectively mounted to and removed from the head section 10 without the use of tools. Two seats 102 are provided in the body portion 12 to house corresponding anchorage members for anchoring lengths of cutting line 100. The seats 102 are delimited, not only by the approximately substantially plane surface 104 made in the body portion 12, but also by a curvilinear surface 106, which is orthogonal to the surface 104 and has an approximately spiral development (see FIGS. 3, 10 and 11). On top, each seat 102 is delimited by the bottom surface of the cap 18, which can be planar.

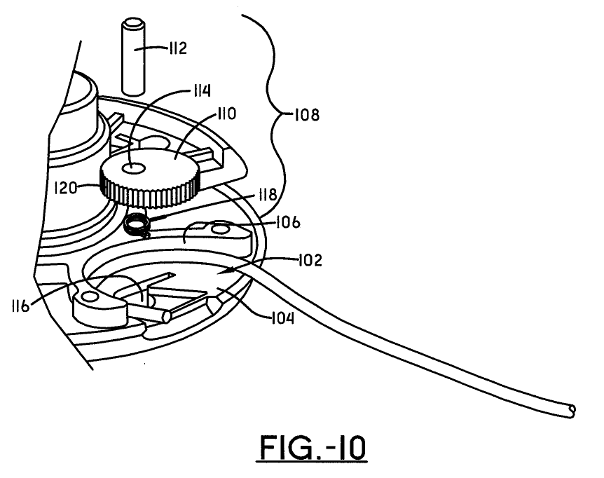

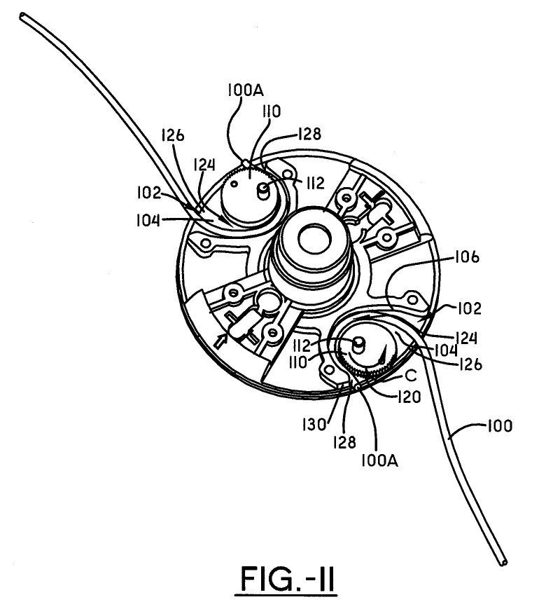

Inserted within each of the two seats 102 is a corresponding anchorage member, as a whole designated by 108, the components of which are illustrated in isolation in the exploded view of FIG. 10. Each anchorage member 108 comprises an eccentric oscillating element 110, of substantially circular cross section, mounted in the corresponding seat 102. The eccentric oscillating element 110 can oscillate about the axis of a pin 112 inserted in a through hole 114 of the element 110. Each pin 112 is inserted in a hole (which may be blind) 116, made in the surface 104 of the corresponding seat 102. A corresponding blind hole is made also in the bottom surface 117 (FIG. 1) of the cap 18, so that each of the two pins 112 is engaged in two opposed and coaxial blind holes in the cap 18 and the body portion 12 of the head section 10.

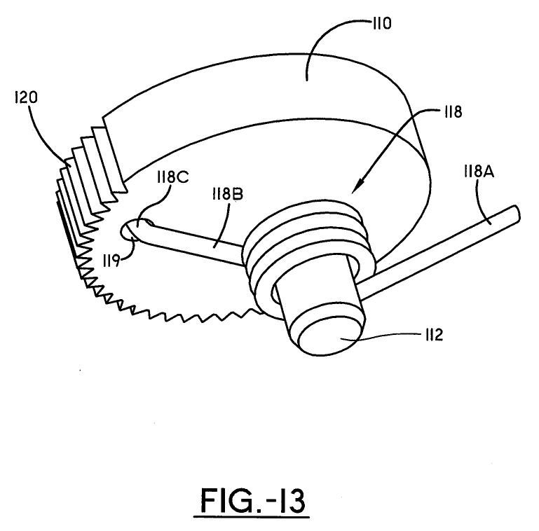

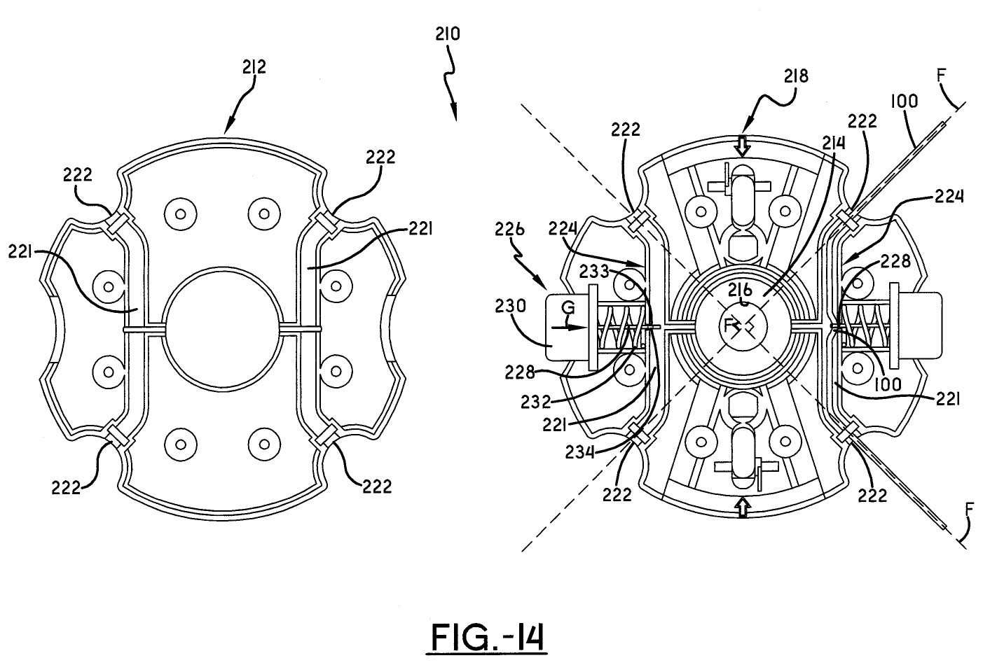

The hole 116 is sized in such a way as to be able to receive, in addition to the pin 112, an elastic member for biasing the eccentric oscillating element 110 to hold the cutting line 100 in place, as will be described more fully below. Here, the elastic member is shown in the form of a torsion spring 118. In FIG. 13, it can be seen that the line forming the torsion spring 118 has appendages 118A and 118B. The appendage 118A is engaged in the appropriately shaped cavity 116A constituted by the hole 116, whilst the appendage 118B has a bent end 118C that is engaged in a corresponding hole 119 made on the bottom face of the corresponding eccentric oscillating element 110. With this arrangement, when the member 108 is assembled, the torsion spring 118 loads the eccentric oscillating element 110 in a resting position, from which the element itself can be made to oscillate, deforming the torsion spring 118.

The eccentric oscillating elements 110 include knurling 120, which may be straight or diamond or otherwise shaped, for the purposes that will be clarified hereinafter. The eccentric oscillating elements 110 are mounted in the respective seats 102 in such a way as to project at least a portion of its knurling 120 through its respective line entrance opening 122 (FIG. 1). It is thus possible for the user to contact this knurled part of the edge of each eccentric oscillating element 110 to bring about an oscillation of the eccentric oscillating element 110 for the purpose of releasing the cutting line 100 and enabling its replacement in the event of wear.

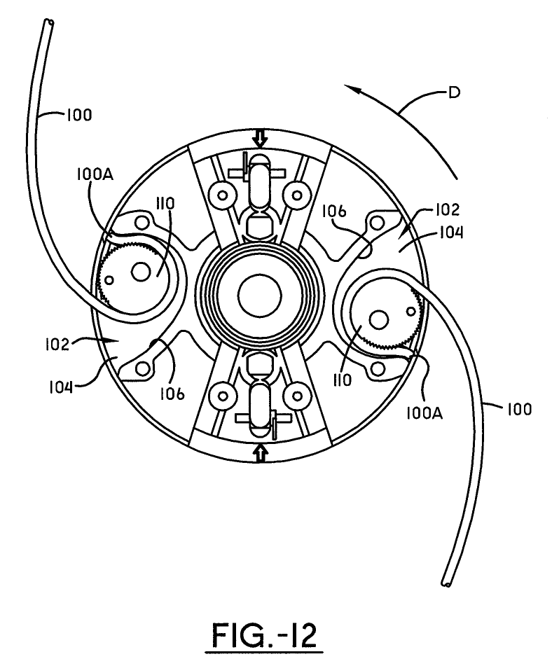

As perhaps best seen in FIG. 11, a channel 124 with a progressively decreasing cross section is formed in each of the seats 102 between the spiral-shaped surface 106 and the circular edge of the eccentric oscillating element 110. The cross section progressively decreases from a mouth 126, at the line entrance opening 122, to a grip area 128 proximate a rounded-off edge 130 at which the surface 106 terminates. The rounded-off edge 130 basically joins the surface 106 with the perimeter of the body portion 12. The eccentric oscillating element 110 of each anchorage member 108 is elastically loaded against the respective rounded-off edge 130 or, in any case, is loaded towards a position in which it is located at a distance from said edge smaller than the diameter of the cutting line 100. Thus, the grip area 128 is defined where the eccentric oscillating element 110 is close enough to the surface 106 and/or rounded-off edge 130 to pinch and thus grip the cutting line 100.

The securing and removal of a cutting line 100 to the head section 10 is described with reference to FIGS. 11 and 12. A first end 100A of the cutting line 100 is inserted into the mouth 126 of a seat 102 and advanced along the channel 124 formed between the spiral-shaped surface 106 and the circular edge of the eccentric oscillating element 110. The cutting line 100 is thus conveniently guided towards the grip area 128, sliding on the curved surface 106 and wedging between the knurling 120 and the rounded-off terminal edge 130 of the curved surface 106, as may be noted in FIG. 11, where two lengths of cutting line 100 have been completely inserted and anchored in the body portion 12.

To remove a length of cutting line 100, it is sufficient to manipulate the eccentric oscillating element 110 at its knurling 120, a portion of which preferably projects from the line entrance opening 122 as seen in FIG. 1. More particularly, the user can move the eccentric oscillating element 110, in the direction of arrow C of FIG. 11, against the bias of the torsion spring 118 with his/her finger, with the knurling 120 providing a better grip. This movement will increase the distance between the eccentric oscillating element 110 and the surface 106 and/or rounded-off edge 130 to release the first end 100A of the cutting line 100 and enable convenient extraction and subsequent replacement thereof with a new length of cutting line. As the user desires, the cutting line 100 can be removed by pulling on the first end 100A held proximate the rounded-off edge 130 or by puling on the remaining length proximate mouth 126 of channel 124.

With the structure described herein, a cutting line 100 can be mounted to and removed from the head section 10 without the use of any special tools, and, indeed without tools of any kind. A cutting line 100 can be mounted to the head section 10 simply by using one's hands, and without disassembling the head section 10 in any way. Certain elements will pivot and reconfigure, as described, but the head section 10 is always configured to receive a cutting line 100 at a mouth 126 and channel 124, and to permit removal of a cutting line 100, as just described. No cap portion, such as decorative cap 18, or other portion of the head section 10 need be removed or reconfigured to accept a cutting line 100.

When the head section 10 is made to rotate in the direction of arrow D (FIG. 12), the centrifugal force tends to extend the lengths of cutting line 100 in a direction opposite the rotation. The lengths of cutting line 100 thus pull on the eccentric oscillating elements 110 in a direction that urges the knurling 120 toward the grip area facilitating the secure retention of each of the lengths of cutting line 100. The force exerted on the cutting lines 100 by the vegetation being cut during rotation of the mowing head section 10 also contributes to this effect. By so curving, the cutting lines 100 rest on the circular edge of the respective oscillating elements 110, which consequently form a rest with ample curvature for the lines themselves, so reducing the risk of breakage due to the mechanical stresses exerted by the vegetation or by possible obstacles, such as sharp edges of flower beds, stones, clods of earth or the like, on the cutting lines themselves. It should be noted that some rotary cutting devices provide head sections that can be selectively rotated in either a clockwise or a counterclockwise direction, such that the disclosure herein respecting rotation in the direction of arrow D should be understood as exemplary only. The invention is not limited to rotation in any particular direction or to rotary cutting devices that rotate a cutting head in only one direction.

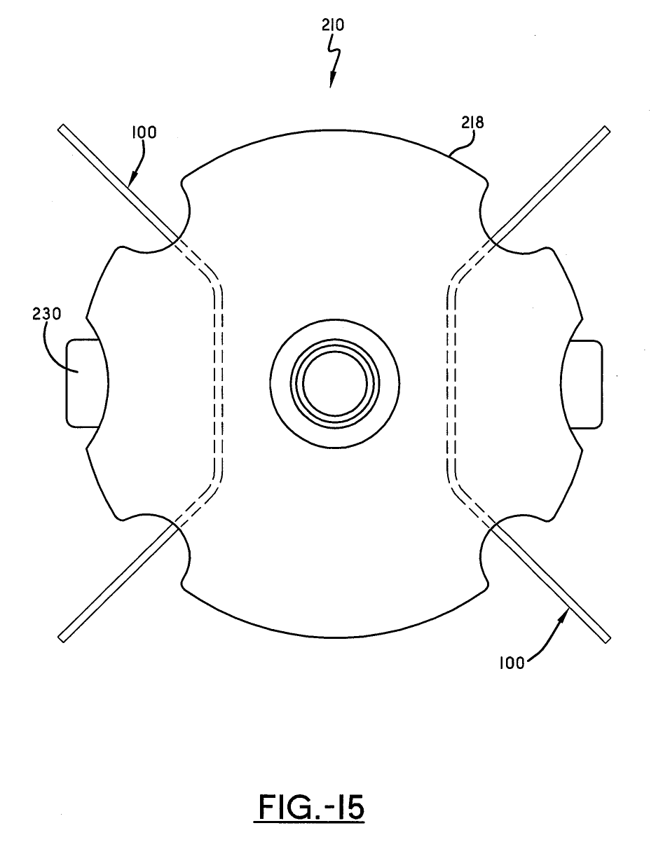

Referring now to FIGS. 14 and 15 an alternative means for mounting individual lengths of cutting lines 100 to a head section 210 is shown. It should be appreciated that these figures show only the mechanisms and structure for securing individual lengths of cutting line, it being understood that the mechanisms already disclosed for securing cutting blades could be configured into the head section 210 at the area E that is not used for securing cutting line.

In FIG. 14, a cap portion 218 is shown removed from a body portion 212, and provides two cutting line passageways 224, each of which are bowed to provide two cutting line openings 222. The degree of the bow is preferably chosen such that the centerlines F of two cutting line openings 222 provided by a particular cutting line passageway 224 lie perpendicularly to each other. With this structure, the two cutting line passageways 224 can be positioned in the head section 210 so that the neighboring lengths of the cutting lines that extend beyond the head section 210 to cut vegetation are offset at 90 degrees from each other. Thus, by employing two individual lengths of cutting line 100, four lengths can be provided external of the head section 210 for cutting vegetation.

Notably, the central passages 221 of the cutting line passageways 224 are positioned so as to provide room for the axial member 214 providing the axial bore 216. This positioning, as already mentioned above, will also permit the incorporation of the cutting blade mounting structures into the head section 210. An anchorage member 226 is provided to interact with the central passage 221 to hold an individual length of cutting line 100 in the head section 210, with the ends of the cutting line 100 extending from the cutting line openings 222. The anchorage member 226 includes a grip plate 228 extending from a push button 230, which is biased by a spring 232 away from the central passage 221. The grip plate 228 extends through an opening 233 of the sidewall of the central passage 221, and provides a cutting line aperture 234 that is held out of alignment with the central passage 221 due to the influence of the spring 232. The cutting line aperture 234 can, however, be brought into alignment with the central passage 221 by pressing on the push button 230 in the direction of arrow G. When the push button 230 is pressed to bring the cutting line aperture 234 into alignment with the central passage 221, a length of cutting line 100 can be inserted into a cutting line opening 222 and through the central passage 221 and the cutting line aperture 234 such that lengths of the cutting line 100 extend beyond the head section 210, as shown. Upon release of the push button 230, the cutting line aperture 234 is moved in the direction opposite arrow G, and the cutting line 100 extending through the cutting line aperture 234 pinched between the wall of the cutting line aperture 234 and the sidewall of the central passage 221 proximate the opening 233.

With this structure, and the understanding that blade mounting structure in accordance with the teaching herein can be implemented into this embodiment, the head section 210 can be selectively configured to provide either four lengths of cutting line offset and 90 degree intervals or two blades offset at 180 degrees. As with the other embodiments, such selective configuration can be achieved without the use of tools and without any disassembly of the head section.

From the forgoing, it should be clear that the present invention provides a significant improvement in head sections for rotary cutting devices in that it provides a single head section that can selectively employ either blades or cutting lines, with the installation and removal of either such cutting element being achieved very quickly and without the use of tools. It is understood that the drawings just show one example, provided merely as practical demonstration of the invention, it being possible for said invention to vary in the shapes and arrangements without on the other hand departing from the scope of the idea underlying the invention itself. As such, the claims that follow shall serve to define the scope of the invention.

What is claimed is:

1. A head section for a rotary cutting device, the head section selectively configurable to hold cutting blades in one configuration and to hold cutting line in another configuration, the head section comprising:
(a) a body portion;
(b) a blade mount assembly in said body portion including:
a blade passage extending through said body portion from a blade entrance opening to a blade exit opening, and
a blade fastening mechanism having a blade engaging member biased by a biasing mechanism to extend across said blade passage at a blade install position, said blade engaging member being movable against such bias to clear said blade passage;
(c) a blade having a mount aperture proximate an insertion end thereof, wherein said blade is selectively secured to said body portion when said mount aperture occupies said blade install position and said blade engaging member extends through said mount aperture;
(d) a cutting line mount assembly in said body portion; and
(e) a cutting line selectively secured to said body portion by said cutting line mount assembly.

2. The head section of claim 1, wherein said cutting line mount assembly includes:
a contact surface formed in said body portion, and
an eccentric oscillating element biased by an eccentric element biasing mechanism to rotate in a direction toward contact with said contact surface; and said cutting line is selectively secured to said body portion when a portion of said cutting line is positioned between said contact surface and said eccentric oscillating element such that a portion of said cutting line is gripped between said oscillating element and said contact surface.

3. The head section of claim 1, wherein said cutting line mount assembly includes:
a cutting line passageway formed in said body portion and providing at least one cutting line opening at the periphery of said body portion; and
a anchorage member including:
a push button accessed at the exterior of said body portion,
a grip plate extending from said push button and into said cutting line passageway through a sidewall of said cutting line passageway,
a cutting line aperture in said grip plate, and
a biasing element acting on said anchorage member to bias said cutting line aperture out of alignment with said cutting line passageway, wherein pressing on said push button brings said cutting line aperture into alignment with said cutting line passageway.

4. The head section of claim 1, wherein said body portion includes a central cavity defined therein, said central cavity having an open end at a bottom surface of said body portion and extending into said body portion.

5. The head section of claim 4, wherein said blade exit opening of said blade passage opens to said central cavity.

6. The head section of claim 5, further comprising a safety button biased by a button biasing mechanism to extend across said blade passage and block said blade exit opening, said safety button being movable against such bias to clear said blade passage and open said blade exit opening.

7. The head section of claim 1, wherein said blade is secured to said body portion by inserting said insertion end of said blade into said blade entrance opening and advancing said mount aperture through said blade passage toward said blade exit opening such that the insertion end contacts said blade engaging member and moves it to clear said blade passage until said mount aperture reaches said blade engaging member and said blade engaging member moves into said mount aperture under the influence of said biasing mechanism to occupy said blade install position.

8. The head section of claim 7, wherein said biasing mechanism of said blade fastening mechanism is a torsion spring.

9. The head section of claim 8, wherein said torsion spring is secured to said blade engaging member.

10. The head section of claim 1, wherein said contact surface of said cutting line mount assembly is defined in a channel in said body portion, said channel defined in part between a curvilinear surface in said body portion and a periphery of said eccentric oscillating element.

11. The head section of claim 10, wherein said channel is further defined by a seat surface and a top surface, said curvilinear surface extending upwardly from said seat surface to contact said top surface, said eccentric oscillating element being positioned between said seat surface and said top surface.

12. The head section of claim 11, wherein said eccentric element biasing mechanism includes a torsion spring and an eccentric element mounting pin.

13. The head section of claim 12, wherein said eccentric oscillating element includes a through hole and is mounted to said body portion of the head section by said eccentric element mounting pin extending through said through hole and engaging holes in said seat surface and said top surface.

14. The head section of claim 13, wherein said channel is accessed at a periphery of said body portion, at a mouth defined between said top surface, said seat surface, said eccentric oscillating element and said curvilinear surface.

15. The head section of claim 14, wherein said top surface is provided by a cap member selectively removable from said body portion.

16. The head section of claim 14, wherein said eccentric oscillating element includes a knurled edge portion on its periphery, said knurled edge portion projecting from said periphery of said body portion, said knurled edge portion forming a gripping surface for selective oscillation of the oscillating element away from said contact surface for release of a cutting line gripped between said oscillating element and said contact surface.

17. The head section of claim 1, wherein both said blade and said cutting line are selectively secured to said head section without disassembling any portion of the head section.

18. The head section of claim 1, wherein both said blade and said cutting line are selectively secured to said head section without the use of tools.
